(19) United States
(12) Patent Application Publication
(10) Pub. No.: US 2023/0074932 A1
(43) Pub. Date: Mar. 9, 2023

(54) SAFETY WATERPROOF INVISIBLE SWITCH AND SANITARY WARE

(71) Applicant: Sizhong SU, Xiamen City (CN)

(72) Inventor: Sizhong SU, Xiamen City (CN)

(21) Appl. No.: 17/987,293

(22) Filed: Nov. 15, 2022

Related U.S. Application Data
(63) Continuation of application No. PCT/CN2021/093910, filed on May 14, 2021.

(30) Foreign Application Priority Data
May 18, 2020 (CN) 202020830297.5

(51) Int. Cl. H01H 13/20; H01H 13/14; A47L 13/58; A47L 13/24; A47L 13/42

(52) U.S. Cl. CPC H01H 13/20; H01H 13/14; A47L 13/58; A47L 13/24; A47L 13/42

(57) ABSTRACT

A safety waterproof invisible switch and a sanitary ware are provided. The safety waterproof invisible switch comprises a button switch, a first member, a second member, a first magnet, and a second magnet. The first magnet is disposed on a button of the button switch, and the second magnet is disposed on the second member. The first member has a hollow cavity. The button switch disposed with the first magnet is disposed in the first member. While the second magnet is adjacent to or in contact with the first member and when magnetic poles of a same polarity of the first magnet and the second magnet oppose each other, the button of the button switch is moved in a pressed direction of the button by a repulsive force.

### RELATED APPLICATIONS

This application is a continuation of and claims priority to international patent application number PCT/CN2021/093910, filed on May 14, 2021, which claims priority to Chinese patent application number 202020830297.5, filed on May 18, 2020. International patent application number PCT/CN2021/093910 and Chinese patent application number 202020830297.5 are incorporated herein by reference.

### FIELD OF THE DISCLOSURE

The present disclosure relates to a switch and in particular to a safety waterproof invisible switch and a sanitary ware.

### BACKGROUND OF THE DISCLOSURE

An electrical switch is a device that can control a turning ON and OFF of a circuit, and its application is very common. At present, most switches use a direct contact method to control an opening and closing of an electrical device. However, due to a gap between a button part of the electrical switch and a body of the electrical switch, it is difficult to apply the electrical switch in some water-filled occasions, or special treatment is required to prevent water from entering the electrical switch. For example, when the electrical switch is applied to a dehydration device configured for an electric mop, the electrical switch is often installed on a dehydration rotating shaft of the dehydration device and controlled by the electric mop. This requires that the electrical switch be waterproofed, but it is difficult to waterproof the electrical switch and there is a problem of a poor waterproof effect.

### BRIEF SUMMARY OF THE DISCLOSURE

The present disclosure provides a safety waterproof invisible switch and a sanitary ware to solve the deficiencies in the background.

In order to solve the technical problem, a first technical solution of the present disclosure is as follows. A safety waterproof invisible switch comprises a button switch, a first member, a second member, a first magnet, and a second magnet. The first magnet is disposed on a button of the button switch, the second magnet is disposed on the second member, the first member has a hollow cavity, and the button switch disposed with the first magnet is disposed in the first member. While the second magnet is adjacent to or in contact with the first member and when magnetic poles of a same polarity of the first magnet and the second magnet oppose each other, the button of the button switch is moved in a pressed direction of the button by a repulsive force.

In a preferred embodiment, the first magnet is disposed on an upper end of the button, and the button of the button switch disposed with the first magnet is disposed on a top of the hollow cavity of the first member.

In a preferred embodiment, a gap is defined between a side surface of the button switch and an inner surface of the first member.

In a preferred embodiment, the second member is a switch lid configured to cover the first member, and the second magnet is fixedly connected in the switch lid.

In a preferred embodiment, a radial diameter of the switch lid gradually increases from top to bottom. Alternatively, a bottom opening of the switch lid is flared and the second magnet is fixedly connected to a top of an inner cavity of the switch lid.

In a preferred embodiment, the first member is a switch cover having a bottom opening.

In a preferred embodiment, the button switch is a self-resetting button switch configured to be reset to an original position.

A second technical solution of the present disclosure is as follows. A sanitary ware comprises a mop, a barrel, and the safety waterproof invisible switch. The first member is a dehydration rotating shaft, which is rotatably disposed on the barrel around an axis of the dehydration rotating shaft, and the dehydration rotating shaft is configured to be driven by a motor disposed on the barrel. The button switch is a self-resetting button switch configured to be reset to an original position and electrically connected to an electrical circuit to which the motor is connected to control whether the motor is started or not. The second member is disposed on a mop head of the mop.

In a preferred embodiment, the second member and the mop head are integrally formed.

In a preferred embodiment, a top of the dehydration rotating shaft is sleeved with a protective cover.

In a preferred embodiment, the motor is disposed in a cavity defined in the barrel, and an output shaft of the motor is operatively coupled to the dehydration rotating shaft through a transmission assembly.

Compared with the existing techniques, the technical solution has the following advantages.

1. In the present disclosure, the button switch is arranged in the first member and controlled by the magnetic repulsive force of the first magnet and the second magnet, which can avoid accidental touch by children and the like, and the button switch is disposed in a relatively sealed space. The button switch will not come into contact with water, and the button switch achieves waterproof effect. In addition, the button switch is not exposed, which can make the appearance of the product more concise and beautiful.

2. The second member is preferably the switch lid that can cover the first member, and the switch lid can be used to guide and limit a position of the second magnet, so as to avoid a lateral deviation of the second magnet due to the repulsive force, which causes the repulsive force to decrease or deviate from direction.

3. When the safety waterproof invisible switch of the present disclosure is applied to the sanitary ware, the first member is used as the dehydration rotating shaft, and the second member is set on the mop head of the mop. The mop can automatically control whether the motor starts or not. At the same time, and the button switch can avoid being in contact with water, so that the product performance is stable.

### BRIEF DESCRIPTION OF THE DRAWINGS

FIG. 1 illustrates a cross-sectional view of a safety waterproof invisible switch of Embodiment 1 of the present disclosure.

FIG. 2 illustrates an exploded view of a sanitary ware in Embodiment 2 of the present disclosure.

FIG. 3 illustrates a top view of a mop head and a dehydration rotating shaft of the sanitary ware of the present disclosure when the mop head and the dehydration rotating shaft are in a mating state.

FIG. 4 illustrates a cross-sectional view taken along line A-A of FIG. 3 (a button switch is only partially shown).

FIG. 5 illustrates a cross-sectional view taken along line B-B in FIG. 2.

FIG. 6 illustrates a cross-sectional view of the sanitary ware when the mop head shown in FIG. 5 is pressed to be in a pressed state.

### DETAILED DESCRIPTION OF THE EMBODIMENTS

The present disclosure will be further described below in combination with the accompanying drawings and embodiments.

The terms “first”, “second”, and similar terms used in the present disclosure do not denote any order, quantity, or importance in the present disclosure, but are used to distinguish one component from other components.

Some directional terms used to describe the drawings, such as “center”, “lateral”, “longitudinal”, “horizontal”, “vertical”, “top”, “bottom”, “inner”, “outer”, “above”, “below”, “front”, “rear”, “left”, “right”, “clockwise”, “counterclockwise”, and other directional terms will be understood to have their normal meaning and refer to those directions involved in normal viewing of the drawings. Unless otherwise indicated, directional terms described herein substantially follow conventional directions as understood by those skilled in the art.

### Embodiment 1

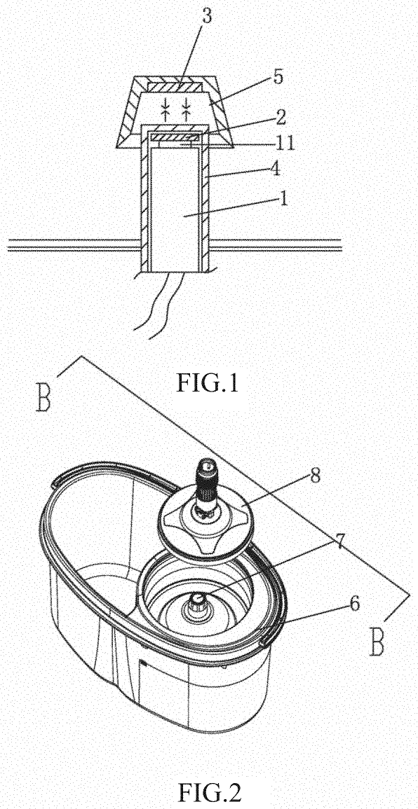

Referring to FIG. 1, a safety waterproof invisible switch of the present disclosure comprises a button switch 1, a first member, a second member, a first magnet 2, and a second magnet 3. The first magnet 2 is disposed on a button 11 of the button switch 1, and the second magnet 3 is disposed on the second member. The first member has a hollow cavity, and the button switch 1 is disposed in the first member. While the second magnet 3 is adjacent to or in contact with the first member and when magnetic poles of the same polarity of the first magnet 2 and the second magnet 3 oppose each other, the button 11 of the button switch 1 is moved in a pressed direction thereof by a repulsive force (where the pressed direction is downward in FIG. 1).

In this embodiment, the first magnet 2 is disposed on an upper end of the button 11, and the button 11 of the button switch 1 is disposed on a top of the hollow cavity of the first member. The first member is a switch cover 4 having a bottom opening. The button 11 of the button switch 1 faces an inner top surface of the switch cover 4, and a gap is defined between an outer surface of the button switch 1 and an inner surface of the switch cover 4, so that the switch cover 4 and the button switch 1 are relatively independent of each other and will not affect each other.

In this embodiment, the second member is a switch lid 5, and the second magnet 3 is fixedly connected to a top of an inner cavity of the switch lid 5. A radial dimension of the switch lid 5 gradually increases from top to bottom, so that the switch lid 5 can cover the switch cover 4 more easily. In other embodiments, a bottom opening of the switch lid 5 is flared, so that the switch lid 5 easily covers the switch cover 4. The second magnet 3 is fixedly connected to the top of the inner cavity of the switch lid 5.

In this embodiment, a magnetic pole on an upper surface of the first magnet 2 and a magnetic pole on a lower surface of the second magnet 3 have a same polarity.

In this embodiment, the button switch 1 is a self-resetting button switch configured to be reset to an original position, but the button switch 1 is not limited to this, and other types of button switches are also applicable.

When in use, when the switch lid 5 with the second magnet 3 disposed therein is adjacent to or in contact with the switch cover 4 disposed with the first magnet 2 and when the magnetic poles of the same polarity of the first magnet 2 and the second magnet 3 oppose each other, the button 11 of the button switch 1 is moved in the switch cover 4 along the pressed direction of the button 11 due to the repulsive force (where the pressed direction is downward in FIG. 1).

When the switch lid 5 is separated from the switch cover 4, the button 11 is automatically reset to the original position. That is, the button 11 is moved in the inner cavity of the switch cover 4 in an upward direction.

In the safety waterproof invisible switch of the present disclosure, the button switch 1 is disposed in the switch cover 4, and the safety waterproof invisible switch is configured to be controlled by a magnetic repulsive force between the first magnet 2 and the second magnet 3, which can avoid accidental contact by children and other dangers. In addition, the button switch 1 is disposed in a relatively sealed space and will not be exposed to water, achieving a waterproof effect. In addition, the button switch 1 is not exposed, which can also make an appearance of this product more concise and beautiful.

The safety waterproof invisible switch of the present disclosure can not only be applied to sanitary wares but also can be applied to other products that require waterproof or concealment of button switches.

### Embodiment 2

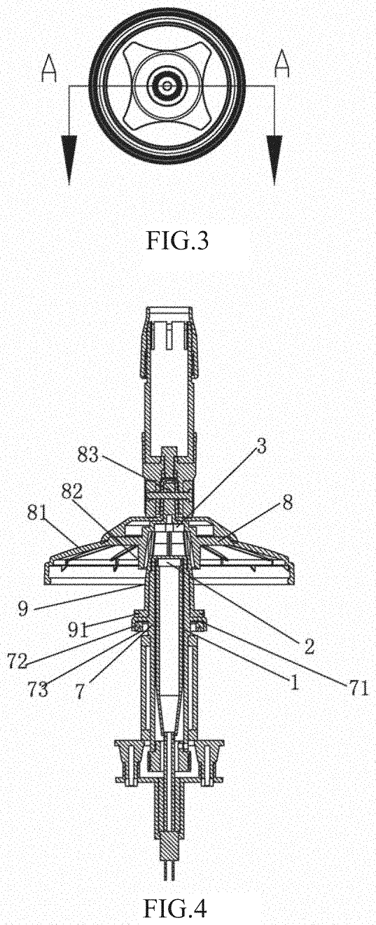

Referring to FIGS. 2 to 4, a sanitary ware of the present disclosure comprises a mop (only a mop head 8 of the mop is shown in the figures) and a barrel 6, and the sanitary ware further comprises the safety waterproof invisible switch described in Embodiment 1 of the present disclosure. The first member is a dehydration rotating shaft 7, which is rotatably disposed on the barrel 6 around an axis of the dehydration rotating shaft 7, and the dehydration rotating shaft 7 is driven by a motor (not shown in the figures) disposed on the barrel 6. The button switch 1 is electrically connected to an electrical circuit to which the motor is connected to control whether the motor is started or not. The second member (i.e., a second switch lid 82) is disposed on the mop head 8 of the mop, and the second switch lid 82 and the mop head 8 are integrally formed.

In this embodiment, the mop head 8 comprises a second switch lid 82 having a bottom opening, a fixed disk 81, and a mounting handle 83, and the second switch lid 82, the fixed disk 81, and the mounting handle 83 are coaxially arranged. An inner cavity of the second switch lid 82 is step-shaped, an inner diameter of a bottom end of the inner cavity of the second switch lid 82 is matched with a front end of the dehydration rotating shaft 7, and an upper part of the inner cavity of the second switch lid 82 is fixedly disposed with the second magnet 3. A middle of an outer wall of the second switch lid 82 is disposed with the fixed disk 81 extending along a circumferential direction of the second switch lid 82, and the mounting handle 83 is disposed on a top of the outer wall of the second switch lid 82 in an axial direction (i.e., in a direction of an axis about which the second switch lid 82, the fixed disk 81, and the mounting handle 83 are coaxially arranged).

In this embodiment, the dehydration rotating shaft 7 has a hollow shaft cavity, the hollow shaft cavity comprises a top end, and the top end is closed. The first magnet 2 is embedded in the upper end of the button 11 and placed in the hollow shaft cavity of the dehydration rotating shaft 7. The button 11 can move up and down in the hollow shaft cavity of the dehydration rotating shaft 7. A top of the dehydration rotating shaft 7 is also sleeved with a protective cover 9.

In this embodiment, the motor is disposed in a cavity defined in the barrel 6, and an output shaft of the motor is operatively coupled to the dehydration rotating shaft 7 through a transmission assembly. The transmission assembly may be a gear transmission assembly or a pulley transmission assembly.

In this embodiment, the magnetic pole on the upper surface of the first magnet 2 and the magnetic pole on the lower surface of the second magnet 3 have the same polarity.

When the mop is being used, the mop head 8 of the mop is disposed on the dehydration rotation shaft 7. At the same time, the second magnet 3 in the mop head 8 is adjacent to the first magnet 2 disposed in the dehydration rotation shaft 7. The magnetic poles of the same polarity of the first magnet 2 and the second magnet 3 oppose each other, so that the repulsive force is generated between the first magnet 2 and the second magnet 3, and the repulsive force is configured to drive the button 11 of the button switch 1 in the dehydration rotation shaft 7 to move downward to turn on the electrical circuit to which the motor is connected. The motor is started to drive the dehydration rotating shaft 7 to drive the mop or the mop head 8 to rotate to achieve centrifugal dehydration. After the centrifugal dehydration is complete, the mop is lifted to separate the second magnet 3 away from the first magnet 2, the repulsive force between the first magnet 2 and the second magnet 3 disappears, and the button of the button switch 1 is automatically reset to the original position, thereby disconnecting the electrical circuit to which the motor is connected to stop the motor.

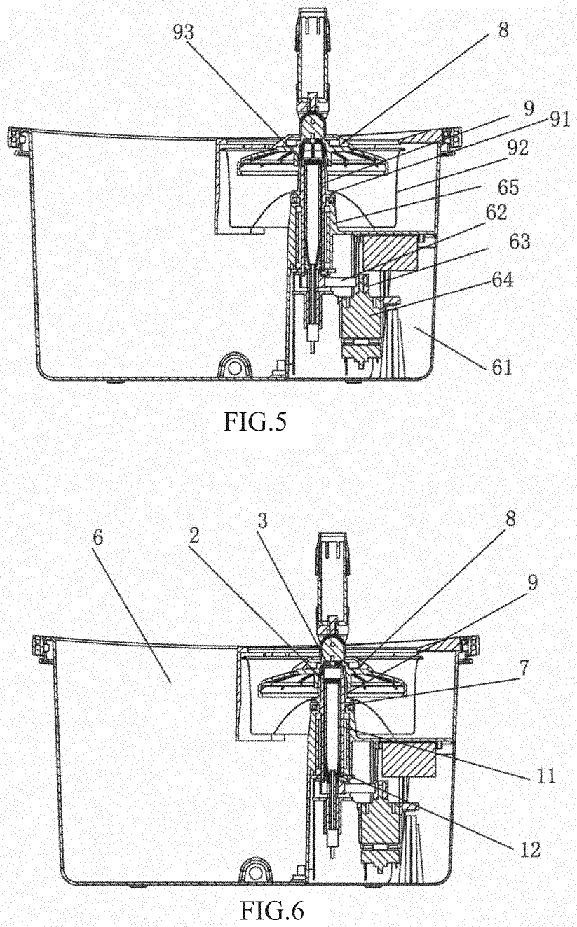

In the sanitary ware of this embodiment, referring to FIGS. 2-6, a lower end of the protective cover 9 comprises an annular surface 91, which is fixedly connected to a drain basket 92, and an upper end of the protective cover 9 comprises a through hole 93.

The barrel 6 comprises a power cavity 61, and the power cavity 61 comprises an assembly sleeve 65. The transmission assembly is a belt pulley transmission assembly 62, an output shaft 63 of a motor 64 is operatively coupled to the belt pulley transmission assembly 62, and the belt pulley transmission assembly 62 and the motor 64 are each disposed in the power cavity 61.

A positioning flange 71 extends on a middle of the dehydration rotating shaft 7. A lower end surface of the positioning flange 71 is recessed with a sealing groove 72 in which a sealing ring 73 is disposed. A lower end of the dehydration rotating shaft 7 is inserted into the power cavity 61 through the assembly sleeve 65, and the positioning flange 71 is hermetically connected to an upper portion of the assembly sleeve 65. The drain basket 92 is detachably sleeved on the dehydration rotating shaft 7 through the protective cover 9, the through hole 93 is clamped on an edge of an upper end surface of the dehydration rotating shaft 7, and the drain basket 92 rotates synchronously with the dehydration rotating shaft 7 when the mop is in use. Therefore, a structure of this embodiment has a good sealing effect on the button 11 in the dehydration rotating shaft 7, and the drain basket 92 will not cause misoperation of the button 11 during cleaning. At the same time, a design of the through hole 93 on the upper end of the protective cover 9 enables an isolation layer of the second magnet 3 acting on the first magnet 2 to be omitted, and the repulsive force pushing the button 11 to move has a better effect.

In this embodiment, the button switch 1 is the self-reset button switch, and the button 11 and a resetting spring 12 are placed in the dehydration rotating shaft 7.

In this embodiment, the button switch 1 is hidden in the dehydration rotating shaft 7, and the button switch 1 can be turned on only through the second magnet 3 disposed in the mop head 8. Therefore, a safety effect is achieved by avoiding accidental touch by children and other dangers. The button switch 1 is placed in a relatively sealed space and will not be exposed to water, achieving a waterproof effect. At the same time, the button switch 1 is not exposed, making the product more concise and beautiful.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A safety waterproof invisible switch, comprising:
a button switch,
a first member,
a second member,
a first magnet, and
a second magnet, wherein:
the first magnet is disposed on a button of the button switch,
the second magnet is disposed on the second member,
the first member has a hollow cavity,
the button switch disposed with the first magnet is disposed in the first member, and
while the second magnet is adjacent to or in contact with the first member and when magnetic poles of a same polarity of the first magnet and the second magnet oppose each other, the button of the button switch is moved in a pressed direction of the button by a repulsive force.

2. The safety waterproof invisible switch according to claim 1, wherein:
the first magnet is disposed on an upper end of the button, and
the button of the button switch disposed with the first magnet is disposed on a top of the hollow cavity of the first member.

3. The safety waterproof invisible switch according to claim 1, wherein:
a gap is defined between a side surface of the button switch and an inner surface of the first member.

4. The safety waterproof invisible switch according to claim 1, wherein:
the second member is a switch lid configured to cover the first member, and
the second magnet is fixedly connected in the switch lid.

5. The safety waterproof invisible switch according to claim 4, wherein:
a radial diameter of the switch lid gradually increases from top to bottom, or
a bottom opening of the switch lid is flared and the second magnet is fixedly connected to a top of an inner cavity of the switch lid.

6. The safety waterproof invisible switch according to claim 1, wherein:
the first member is a switch cover having a bottom opening.

7. The safety waterproof invisible switch according to claim 1, wherein:
the button switch is a self-resetting button switch configured to be reset to an original position.

8. The safety waterproof invisible switch according to claim 1, wherein:
the first member is a switch cover having a bottom opening,
the button switch disposed with the first magnet is disposed in the switch cover,
the second member is a switch lid configured to cover the switch cover,
while the switch lid is adjacent to or in contact with the switch cover and when the magnetic poles of the same polarity of the first magnet and the second magnet oppose each other, the button of the button switch is moved in the switch cover along the pressed direction of the button due to the repulsive force, and
when the switch lid is separated from the switch cover:
the button is moved in an inner cavity of the switch cover in an upward direction to be automatically reset to an original position.

9. A sanitary ware, comprising:
a mop,
a barrel, and
the safety waterproof invisible switch according to claim 1, wherein:
the first member is a dehydration rotating shaft, which is rotatably disposed on the barrel around an axis of the dehydration rotating shaft,
the dehydration rotating shaft is configured to be driven by a motor disposed on the barrel,
the button switch is a self-resetting button switch configured to be reset to an original position and electrically connected to an electrical circuit to which the motor is connected to control whether the motor is started or not, and
the second member is disposed on a mop head of the mop.

10. The sanitary ware according to claim 9, wherein:
the second member and the mop head are integrally formed.

11. The sanitary ware according to claim 9, wherein:
the mop head comprises a second switch lid having a bottom opening and defining the second member, a fixed disk, and a mounting handle,
the second switch lid, the fixed disk, and the mounting handle are coaxially arranged,
an inner cavity of the second switch lid is step-shaped,
an inner diameter of a bottom end of the inner cavity of the second switch lid is matched with a front end of the dehydration rotating shaft,
an upper part of the inner cavity of the second switch lid is fixedly disposed with the second magnet,
a middle of an outer wall of the second switch lid is disposed with the fixed disk extending along a circumferential direction of the second switch lid, and
the mounting handle is disposed on a top of the outer wall of the second switch lid in an axial direction.

12. The sanitary ware according to claim 9, wherein:
the dehydration rotating shaft has a hollow shaft cavity comprising a top end that is closed,
the button of the button switch disposed with the first magnet is disposed in the hollow shaft cavity of the dehydration rotating shaft,
a top of the dehydration rotating shaft is sleeved with a protective cover,
the motor is disposed in a cavity defined in the barrel, and
an output shaft of the motor is operatively coupled to the dehydration rotating shaft through a transmission assembly.

13. The sanitary ware according to claim 12, wherein:
a lower end of the protective cover comprises an annular surface, which is fixedly connected to a drain basket, and
an upper end of the protective cover comprises a through hole.

14. The sanitary ware according to claim 13, wherein:
the cavity comprises an assembly sleeve,
a positioning flange extends on a middle of the dehydration rotating shaft,
a lower end surface of the positioning flange is recessed with a sealing groove in which a sealing ring is disposed,
a lower end of the dehydration rotating shaft is disposed in the cavity through the assembly sleeve,
the positioning flange is hermetically connected to an upper portion of the assembly sleeve,
the drain basket is detachably sleeved on the dehydration rotating shaft through the protective cover,
the through hole is clamped on an edge of an upper end surface of the dehydration rotating shaft, and
the drain basket is configured to rotate synchronously with the dehydration rotating shaft when the mop is in use.

15. The safety waterproof invisible switch according to claim 7, wherein:
the first member is a switch cover having a bottom opening,
the button switch disposed with the first magnet is disposed in the switch cover,
the second member is a switch lid configured to cover the switch cover,
while the switch lid is adjacent to or in contact with the switch cover and when the magnetic poles of the same polarity of the first magnet and the second magnet oppose each other, the button of the button switch is moved in the switch cover along the pressed direction of the button due to the repulsive force, and
when the switch lid is separated from the switch cover:
the button is moved in an inner cavity of the switch cover in an upward direction to be automatically reset to the original position.

16. The sanitary ware according to claim 10, wherein:
the mop head comprises a fixed disk and a mounting handle,
the second member is a second switch lid having a bottom opening,
the second switch lid, the fixed disk, and the mounting handle are coaxially arranged, an inner cavity of the second switch lid is step-shaped,
an inner diameter of a bottom end of the inner cavity of the second switch lid is matched with a front end of the dehydration rotating shaft,
an upper part of the inner cavity of the second switch lid is fixedly disposed with the second magnet,
a middle of an outer wall of the second switch lid is disposed with the fixed disk extending along a circumferential direction of the second switch lid, and
the mounting handle is disposed on a top of the outer wall of the second switch lid in an axial direction.
